(19) United States
(12) Patent Application Publication
(10) Pub. No.: US 2007/0081321 A1
(43) Pub. Date: Apr. 12, 2007

(54) Backlight unit and display apparatus having the same

(76) Inventors: Seung-Ho Ahn, Seongnam-si (KR); Do-Hyung Kim, Suwon-si (KR); Dong-Ho Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/247,882

(22) Filed: Oct. 10, 2005

(51) Int. Cl. G09F 13/04

(52) U.S. Cl. 362/97

(57) ABSTRACT

In a backlight unit and a display apparatus having the backlight unit, the backlight unit includes a first light source, a second light source, and an optical plate having a lower surface facing the second light source and an upper surface substantially parallel with the lower surface. The first light source generating a first light having a first wavelength range. The second light source generating a second light having a second wavelength range different from the first wavelength range to compensate the first light. Thus, display quality of display apparatus may be improved.

### BACKGROUND OF THE INVENTION

1. Field of the Invention

The present invention relates to a backlight unit and a display apparatus having the same. More particularly, the present invention relates to a backlight unit having improved display quality and a display apparatus having the backlight unit.

2. Description of the Related Art

In general, a liquid crystal display apparatus includes a liquid crystal display panel configured to display images using light and a backlight unit to generate the light. The liquid crystal display panel includes an array substrate, a color filter substrate opposite the array substrate, and a liquid crystal layer disposed between the array substrate and the color filter substrate. The color filter substrate includes a color filter layer having a red color pixel, a blue color pixel, and a green color pixel to display a color on a screen of the liquid crystal display panel.

The backlight unit includes a cold cathode fluorescent lamp to generate white light in which red light, green light, and blue light are mixed. However, when light emitted from fluorescent lamp passes through the color filter, each amount of red light, blue light and green light may be changed. or according to the nature of filtering at the color filter and wavelength range corresponding to red color, green color and blue color emitted from fluorescent lamp, color imaged at the display may be limited. Consequently, color is expressed at the display within a limited range of color coordinate.

For example, when white light has a smaller amount of red light than blue and green light, an image displayed on the screen of the liquid crystal display panel includes a red portion that is not as clearly presented as compared to the blue and green light portions.

Further, since the cold cathode fluorescent lamp generates white light, the liquid crystal display apparatus does not control a wavelength range of the light supplied to the liquid crystal display panel in accordance with colors displayed on the screen of the liquid crystal display panel. As a result, the liquid crystal display panel has reduced contrast, and a brightness characteristic of the liquid crystal display apparatus is deteriorated.

### SUMMARY OF THE INVENTION

The present invention provides a backlight unit capable of improving display quality. The present invention also provides a display apparatus having the above mentioned backlight unit.

In one aspect of the present invention, a backlight unit includes a first light source, a second light source, and an optical plate. The first light source generating a first light having a first wavelength range, and the second light source generating a second light having a second wavelength range different from the first wavelength range. The optical plate has a lower surface facing the second light source, an upper surface substantially parallel with the lower surface, and a side surface to connect the lower surface with the upper surface.

In another aspect of the present invention, a display apparatus includes a backlight unit and a display panel. The backlight unit includes a first light source, a second light source, and an optical plate. The first light source generating a first light having a first wavelength range, and the second light source generating a second light having a second wavelength range different from the first wavelength range. The optical plate having a lower surface facing the second light source, an upper surface substantially parallel with the lower surface and a side surface to connect the lower surface with the upper surface. The display panel displaying images using the first and second light generated by the backlight unit.

In still another aspect of the present invention, a display apparatus includes a first driving unit, a display unit, a second driving unit, and a backlight unit. The first driving unit generating a first driving signal and a control signal in response to an external signal. The display unit has a plurality of color areas and displays images in response to the first driving signal. The second driving unit generating a second driving signal in response to the control signal from the first driving unit. The backlight unit includes a plurality of luminescent groups corresponding to the color areas. Further, the backlight unit providing the color areas of the display unit with lights having wavelength ranges different from each other, the backlight unit having a plurality of luminescent groups corresponding to the color areas.

According to the above, the backlight unit includes the second light source generating a second light having a second wavelength range different from the first wavelength range so as to compensate the first light that is generated by the first light source having the first wavelength range. Therefore, the display quality of the display apparatus may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view showing a display apparatus according to an embodiment of the present invention;

FIG. 2 is a plan view showing a backlight unit in FIG. 1;

FIG. 3 is an enlarged view showing portion “A” of FIG. 1;

FIG. 4 is a cross-sectional view showing a display apparatus according to another embodiment of the present invention;

FIG. 5 is a plan view showing a backlight unit in FIG. 4;

FIG. 6 is a block diagram illustrating a display apparatus according to another embodiment of the present invention;

FIG. 7 is a cross-sectional view showing an embodiment of the backlight unit in FIG. 6;

FIG. 8 is a plan view showing the backlight unit in FIG. 7;

FIG. 9 is a cross-sectional view showing a backlight unit according to another embodiment of the present invention; and

FIG. 10 is a plan view showing the backlight unit in FIG. 9.

### DETAILED DESCRIPTION OF THE INVENTION

Hereinafter, the present invention will be explained in detail with reference to the accompanying drawings.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer or section from another region, layer, or section. Thus, a first element, component, region, layer, or section discussed below could be termed a second element, component, region, layer, or section without departing from the teachings of the present invention.

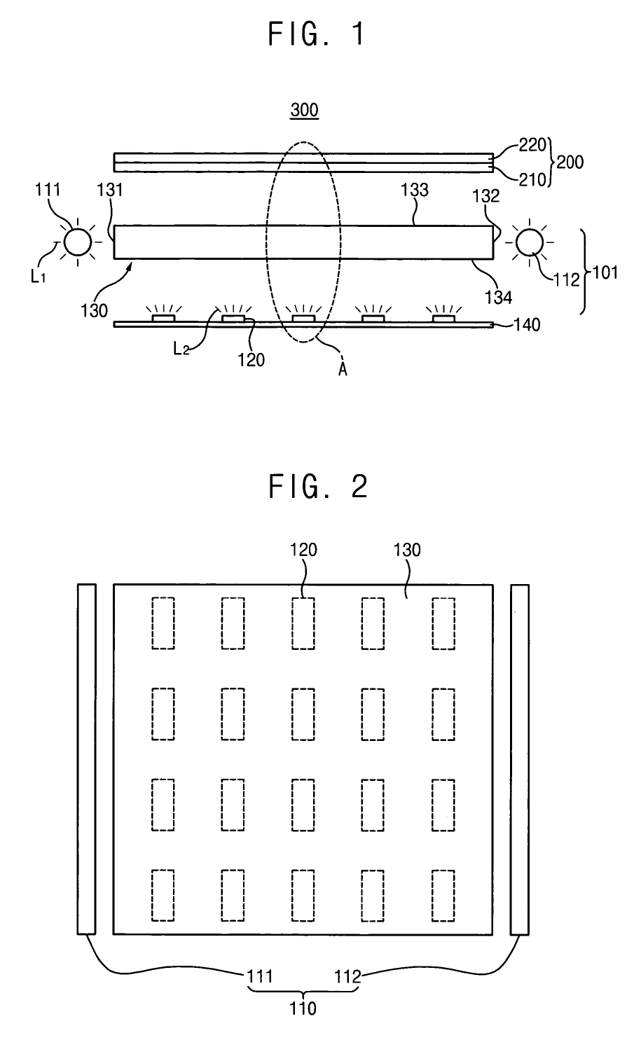

FIG. 1 is a cross-sectional view showing a display apparatus according to an embodiment of the present invention. FIG. 2 is a plan view showing a backlight unit in FIG. 1.

Referring to FIGS. 1 and 2, a display apparatus 300 according to an embodiment of the present invention includes a backlight unit 101 and a display panel 200. In this embodiment, the display apparatus 300 employs an edge illumination type backlight unit only for the exemplary purpose. The backlight unit 101 generates a first light L1 and a second light L2. The display panel 200 is configured to display images using the first light L1 and the second light L2.

The backlight unit 101 includes a first light source 110, a second light source 120, an optical plate such as a light guiding plate 130, and a reflecting plate 140. The first and second light sources 110, 120 generate the first light L1 and the second light L2, respectively. The light guiding plate 130 guides the first light L1 and the second light L2 toward the display panel 200. The light guiding plate 130 includes a lower surface 134 facing the second light source 120, an upper surface 133 substantially parallel with the lower surface 134, and side surfaces 131, 132 connecting the upper surface 133 with the lower surface 134. A portion of the first and second light L1, L2 directed toward the reflecting plate 140 by the first and second light sources 110, 112 is reflected by the reflecting plate 140 substantially toward the upper surface 133 of the light guiding plate 130.

The first light source 110 includes a first lamp 111 and a second lamp 112 to generate the first light L1. For example, each of the first and second lamps 111, 112 includes a cold cathode fluorescent lamp having a tubular shape. The first lamp 111 is disposed adjacent to the first side surface 131 of the light guiding plate 130. The second lamp 112 is disposed adjacent to the second side surface 132 of the light guiding plate 130. The first light L1 generated by the first and second lamps 111, 112 includes white light in which red light, blue light, and green light are mixed.

The second light source 120 has a plurality of organic electro luminescent devices configured to generate the second light L2. The organic electro luminescent devices are disposed on the reflecting plate 140 in a matrix shape. The second light L2 includes one of the red light, the blue light, and the green light.

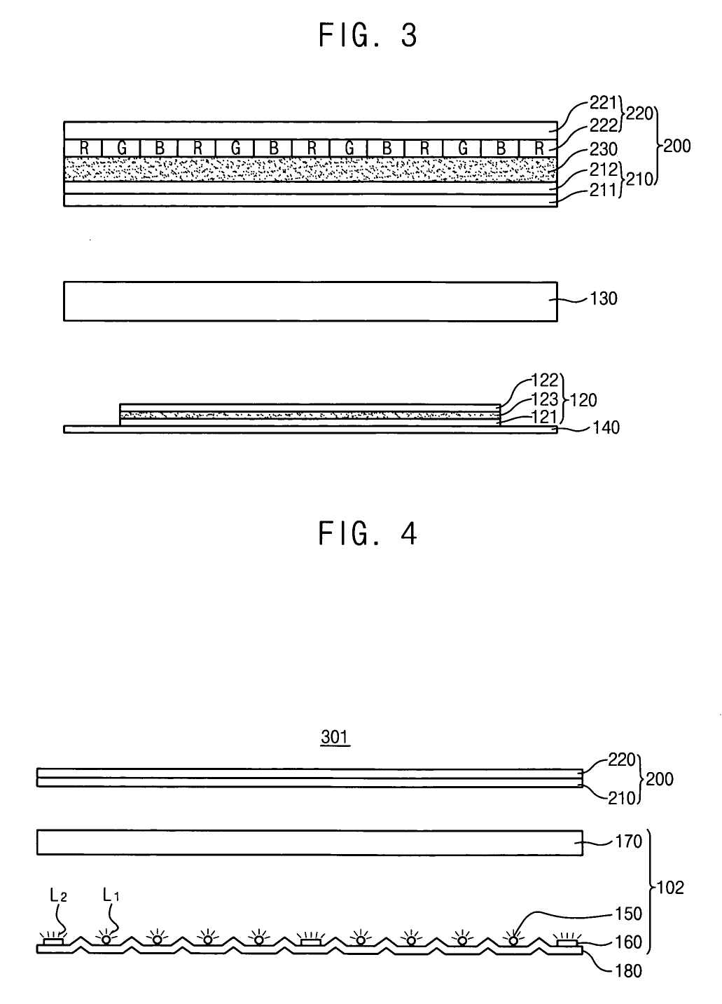

For example, when the first light L1 generated from the first light source 110 includes a smaller amount of red light than the green and blue lights, the second light source 120 is configured to provide the second light L2 having light with a red wavelength range to compensate for the reduced amount of red light in the first light L1. The second light source 120 includes the organic electro luminescent devices configured to generate the second light L2 having the red wavelength range. The organic electro luminescent devices include a luminescent layer having a red organic material. The luminescent layer will be explained in detail with reference to FIG. 3.

As described above, the second light source 120 generates one of the red light, the green light, and the blue light to compensate for a light amount of a predetermined wavelength range from the first light L1. Alternatively, the second light source 120 may generate the second light L2 corresponding to at least two of the red light, the green light and the blue light. When the second light source 120 generates the second light L2 corresponding to at least two of the red light, the green light, and the blue light, the second light L2 may compensate the light amount of the first light L1 corresponding to at least two predetermined wavelength ranges of the first light L1.

As described above, the backlight unit 101 includes the first light source 110 to generate the first light L1 and the second light source 120 to generate the second light L2 that compensates for the first light L1. Therefore, light brightness and light contrast of the display apparatus 300 may be improved, thereby improving display quality of the display apparatus 300.

The display panel 200 includes an array substrate 210 and a color filter substrate 220 facing the array substrate 210. A structure of the display panel 200 will be described below with reference to FIG. 3.

FIG. 3 is an enlarged view showing portion “A” of FIG. 1.

Referring to FIG. 3, the array substrate 210 of the display panel 200 includes a first substrate 211 and a thin film transistor (“TFT”) array layer 212 disposed on the first substrate 211. The color filter substrate 220 of the display panel 200 includes a second substrate 221 and a color filter layer 222 disposed on the second substrate 221. The display panel 200 may further include a liquid crystal layer 230 disposed between the array substrate 210 and the color filter substrate 220.

The TFT array layer 212 has a plurality of TFTs formed on the first substrate 211 in a matrix shape. The color filter layer 222 includes a red color pixel R, a green color pixel G, and a blue color pixel B. Although not shown in FIG. 3, the array substrate 210 may further include a pixel electrode formed on the TFT array layer 212, and the color filter substrate 220 may further include a common electrode formed on the color filter layer 222.

In the backlight unit 101, the first light source 110 generates the first light L1 including the red light having a red wavelength range, the green light having a green wavelength range, and the blue light having a blue wavelength range. Therefore, the red light, the green light, and the blue light of the first light L1 may pass through the red, green, and blue color pixels R, G, and B, respectively. When the first light L1 generated from the first light source 110 includes a smaller amount of red light than the green and blue lights, the second light source 120 generates the second light L2 having the red wavelength range to compensate for the reduced amount of red light in the first light L1.

The second light source 120 includes the organic electro luminescent device that generates the second light L2 having one of the red wavelength range, the green wavelength range, and the blue wavelength range. The organic electro luminescent device includes a first electrode 121, a second electrode 122, and a luminescent layer 123. The first electrode 121 is a cathode electrode and includes a metal material having a low work function, such as magnesium (Mg), lithium (Li), or the like. When the first electrode 121 includes magnesium (Mg), the first electrode 121 further includes silver (Ag) to improve an adhesive force between the first electrode 121 and the luminescent layer 123. When the first electrode 121 includes lithium (Li), the first electrode 121 may further include aluminum (Al). The second electrode 122 is an anode electrode and includes a transparent conductive material such as indium tin oxide (ITO).

The luminescent layer 123 is formed between the first electrode 121 and the second electrode 122. The luminescent layer 123 includes an organic thin layer having a red color, a green color, or a blue color. The organic thin layer may include a low-molecular compound or a high-molecular compound. When the organic thin layer includes the low-molecular compound, the organic electro luminescent device may further include an electron-carrying layer and a hole-carrying layer.

According to a forming process of the organic electro luminescent device, the first electrode 121 is formed on the reflecting plate 140. The luminescent layer 123 is then formed on the first electrode 121 to a thickness from about 100 micrometers to about 200 micrometers, for example, via a vacuum deposition method. Thereafter, the second electrode 122 is formed on the luminescent layer 123, for example, via the vacuum deposition method or a sputtering method. When the organic electro luminescent device is completed, a first voltage and a second voltage are applied to the first and second electrodes 121, 122, respectively. An electric field is formed between the first and second electrodes 121, 122 in response to the first and second voltages. Therefore, the luminescent layer 123 generates the second light L2 including one of the red light, green light, and the blue light.

In FIGS. 1 to 3, the second light source 120 having a plurality of organic electro luminescent devices has been described. Alternatively, the second light source 120 may include a plurality of point light sources such as a plurality of light emitting diodes (LEDs).

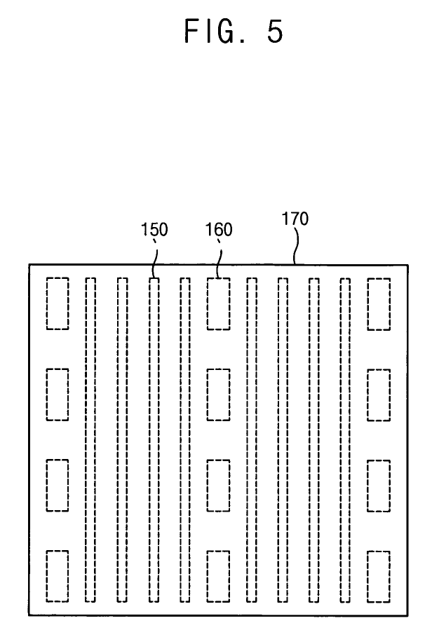

FIG. 4 is a cross-sectional view showing a display apparatus according to another embodiment of the present invention. FIG. 5 is a plan view showing a backlight unit in FIG. 4. In FIGS. 4 and 5, the same reference numerals denote the same elements in FIGS. 1 and 2, and thus any further repetitive descriptions of the same elements will be omitted.

Referring to FIGS. 4 and 5, a display apparatus 301 according to another embodiment of the present invention includes a backlight unit 102 and the display panel 200. In this embodiment, the display apparatus 301 employs a direct illumination type backlight unit only for the exemplary purpose. The backlight unit 102 is configured to generate the first light L1 and the second light L2. The display panel 200 is configured to display images using the first light L1 and the second light L2.

The backlight unit 102 includes a first light source 150, a second light source 160, an optical plate such as a diffusing plate 170, and a reflecting plate 180. The first light source 150 generates the first light L1 and the second light source 160 generates the second light L2. The diffusing plate 170 diffuses the first light L1 and the second light L2. The reflecting plate 180 reflects a portion of the first light and the second light toward the diffusing plate 170.

The first light source 150 includes a plurality of lamps configured to generate the first light L1. Each of the lamps is a cold cathode fluorescent lamp having a tubular shape. The lamps are disposed under the diffusing plate 170 substantially parallel with respect to one another. The first light L1 generated by the lamps includes white light having red light, blue light, and green light.

The second light source 160 includes a plurality of organic electro luminescent devices to generate the second light L2. The organic electro luminescent devices are disposed on the reflecting plate 180. As shown in FIG. 4, for example, the organic electro luminescent devices may be disposed between the lamps as well as at opposite sides of the first light source 150. The organic electro luminescent devices generate the second light L2 having one of the red light, the blue light, and the green light.

For example, when the first light L1 generated from the first light source 150 includes a smaller amount of red light than the green and blue lights, the second light source 160 generates the second light L2 having a red wavelength range to compensate for the reduced red light in the first light L1.

The diffusing plate 170 diffuses the first light L1 and the second light L2 from the first and second light sources 150, 160, respectively. Light diffused by the diffusing plate 170 is supplied to the display panel 200. The reflecting plate 180 reflects an amount of the first and second lights L1, L2 that does not advance toward the diffusing plate 170 from the first and second light sources 150, 160, respectively, to the diffusing plate 170, thereby improving light efficiency.

As described above, in addition to the first light source 150 generating the first light L1, the backlight unit 102 may further include the second light source 160 generating the second light L2 to compensate the first light L1. Therefore, a light brightness and a light contrast of the display apparatus 301 may be improved, thereby improving display quality of the display apparatus 301.

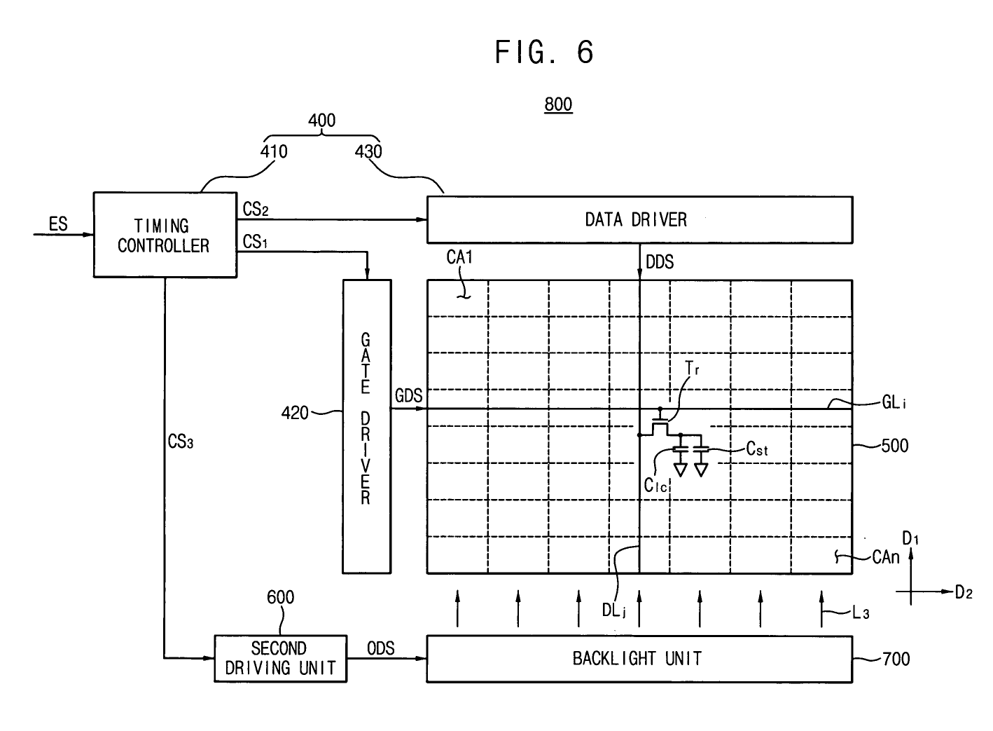

FIG. 6 is a block diagram illustrating a display apparatus according to another embodiment of the present invention.

Referring to FIG. 6, a display apparatus 800 according to another embodiment of the present invention includes a first driving unit 400, a displaying unit 500, a second driving unit 600, and a backlight unit 700.

The first driving unit 400 includes a timing controller 410, a gate driver 420, and a data driver 430. The timing controller 410 outputs a first control signal CS1, a second control signal CS2, and a third control signal CS3 in response to an external signal ES to control the gate driver 420, the data driver 430, and the second driving unit 600, respectively. The gate driver 420 outputs a gate driving signal GDS in response to the first control signal CS1 from the timing controller 410. The first control signal CS1 includes a first timing signal to control a driving time of the gate driver 420 and a driving voltage. The data driver 430 outputs a data driving signal DDS in response to the second control signal CS2 from the timing controller 410. The second control signal CS2 includes a second timing signal to control a driving time of the data driver 430 and image data.

The display unit 500 includes a plurality of gate lines and a plurality of data lines. The data lines are elongated in a first direction D1, and the gate lines are elongated in a second direction D2 substantially perpendicular to the first direction D1. The gate lines traverse the data lines and are insulated from the data lines. The data lines and the gate lines define a plurality of pixel areas having a matrix shape. A thin film transistor (“TFT”) Tr, a liquid crystal capacitor Clc, and a storage capacitor Cst are formed in each of the pixel areas defined by the data lines and the gate lines. For example, a gate electrode of the TFT Tr is electrically connected to an i-th gate line GLi, a source electrode of the TFT Tr is electrically connected to a j-th data line DLi, and a drain electrode of the TFT Tr is electrically connected to the liquid crystal capacitor Clc and the storage capacitor Cst.

When the gate driving signal GDS from the gate driver 420 is applied to the i-th gate line GLi, the TFT is turned on in response to the gate driving signal GDS. The data driving signal DDS from the data driver 430 charges the liquid crystal capacitor Clc and the storage capacitor Cst through the TFT Tr. As a result, the display unit 500 may display an image in response to the gate driving signal GDS and the data driving signal DDS.

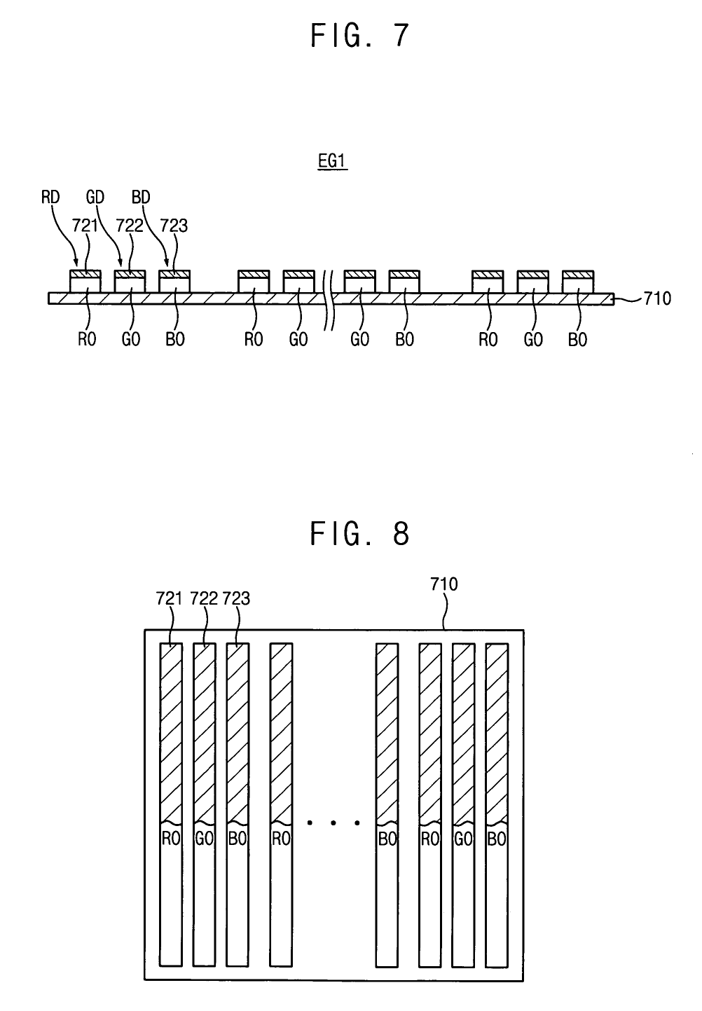

In the present embodiment, the display unit 500 includes n-number color areas CA1˜CAn arranged in a matrix shape, wherein “n” denotes a positive integer. The n-number color areas will be described below with reference to FIGS. 7 to 10.

The second driving unit 600 outputs a driving signal ODS in response to the third control signal CS3 from the timing controller 410. The backlight unit 700 includes a plurality of red organic electro luminescent devices, a plurality of green organic electro luminescent devices, and a plurality of blue organic electro luminescent devices. The red, green, and blue organic electro luminescenct devices generate a third light L3 that includes red light, green light, and blue light in response to the driving signal ODS.

The third control signal CS3 is generated based on red image data, green image data, and blue image data that are included in the second control signal CS2 applied to the data driver 430. Therefore, the third control signal CS3 controls a light amount of the red light, the green light, and the blue light emitted from the backlight unit 700 in accordance with the red, green, and blue image data.

Particularly, the third control signal CS3 increases the light amount of the red light emitted from the red organic electro luminescent devices corresponding to a portion of the display unit 500 to which the red image data are applied. Further, the third control signal CS3 increases the light amount of the green light emitted from the green organic electro luminescent devices corresponding to a portion of the display unit 500 to which the green image data are applied. Further, the third control signal CS3 increases the light amount of the blue light emitted from the blue organic electro luminescent devices corresponding to a portion of the display unit 500 to which the blue image data are applied.

Therefore, a contrast of an image displayed on a screen of the display unit 500 may be increased, so that display quality of the display apparatus 800 may be improved.

Hereinafter, a structure of the backlight unit 700 will be described below with reference to FIGS. 7 to 10. FIG. 7 is a cross-sectional view showing an embodiment of the backlight unit in FIG. 6. FIG. 8 is a plan view showing the backlight unit in FIG. 7.

Referring to FIGS. 7 and 8, the backlight unit 700 includes n-number luminescent groups (not shown) corresponding to the n-number color areas CA1˜CAn (refer to FIG. 6). Each of the luminescent groups includes at least one red organic electro luminescent device, at least one green organic electro luminescent device, and at least one blue organic electro luminescent device. FIGS. 7 and 8 show a first luminescent group EG1 of the luminescent groups corresponding to a first color area CA1.

The first luminescent group EG1 includes a first common electrode 710, a red luminescent layer RO, a green luminescent layer GO, a blue luminescent layer BO, a first electrode 721, a second electrode 722, and a third electrode 723.

In the present embodiment, each of the red organic electro luminescent devices RD is defined by a corresponding region of the first common electrode 710, the red luminescent layer RO, and the first electrode 721. The red luminescent layer RO is disposed between the first common electrode 710 and the first electrode 721. Each of the green organic electro luminescent devices GD is defined by a corresponding region of the first common electrode 710, the green luminescent layer GO, and the second electrode 722. The green luminescent layer GO is disposed between the first common electrode 710 and the second electrode 722. Each of the blue organic electro luminescent devices BD is defined by a corresponding region of the first common electrode 710, the blue luminescent layer BO, and the third electrode 723. The blue luminescent layer BO is disposed between the first common electrode 710 and the third electrode 723. The first, second, and third electrodes 721, 722, and 723 are electrically insulated from each other.

Although not shown in FIGS. 7 and 8, the backlight unit 700 may further include a base substrate on which the red, green, and blue organic electro luminescent devices RD, GD, and BD are formed.

In the present embodiment, the backlight unit 700 may be operated in two operating modes. In a first operating mode, the red, green, and blue organic electro luminescent devices RD, GD, and BD are simultaneously operated. Electric currents different from each other in accordance with the luminescent groups are applied to the red, green, and blue organic electro luminescent devices RD, GD, and BD. Particularly, a same electric current is applied to the red organic electro luminescent devices RD of a same luminescent group, but electric currents different from each other are applied to red organic electro luminescent devices RD of different luminescent groups.

In a second operating mode, the red, green, and blue organic electro luminescent devices RD, GD, and BD are sequentially operated. A first electric current is applied to the red organic electro luminescent devices RD, and a second electric current different from the first electric current is then applied to the green organic electro luminescent devices GD. A third electric current different from the first and second electric currents is applied to the blue organic electro luminescent devices BD.

In the present embodiment, a same electric current is applied to the red organic electro luminescent devices RD included in a same luminescent group, but electric currents different from each other are applied to the red organic electro luminescent devices RD included in the different luminescent groups.

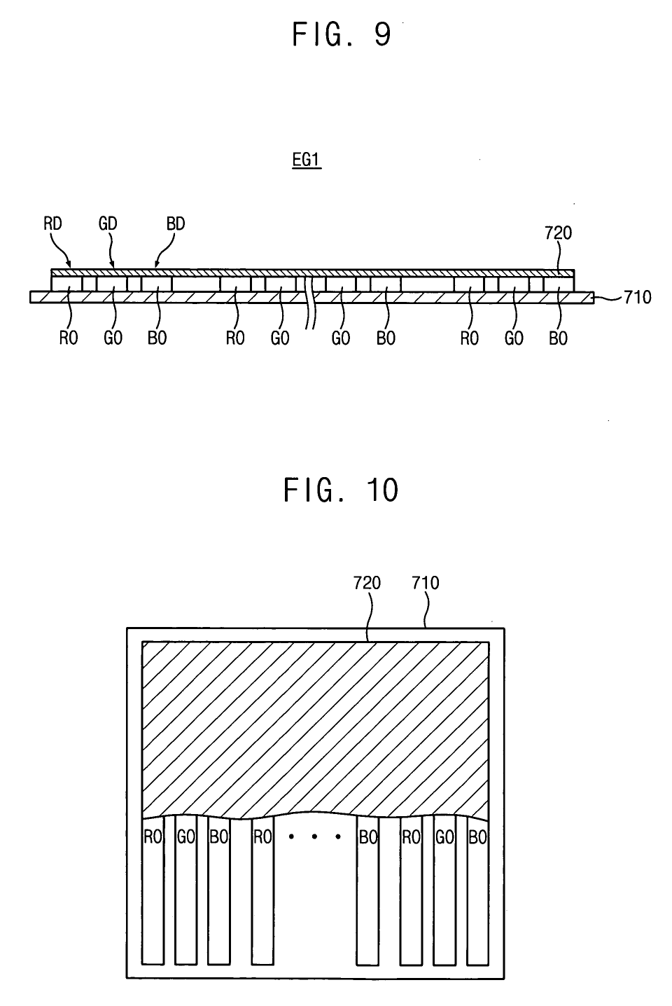

FIG. 9 is a cross-sectional view showing a backlight unit according to another embodiment of the present invention. FIG. 10 is a plan view showing the backlight unit in FIG. 9.

Referring to FIGS. 9 and 10, the first luminescent group EG1 includes the first common electrode 710, a second common electrode 720, the red luminescent layer RO, the green luminescent layer GO, and the blue luminescent layer BO.

Each of the red organic electro luminescent devices RD is defined by a corresponding region of the first common electrode 710, the red luminescent layer RO, and the second common electrode 720. Each of the green organic electro luminescent devices GD is defined by a corresponding region of the first common electrode 710, the green luminescent layer GO, and the second common electrode 720. Each of the blue organic electro luminescent devices BD is defined by a corresponding region of the first common electrode 710, the blue luminescent layer BO, and the second common electrode 720.

In the present embodiment, the red, green, and blue organic electro luminescent devices RD, GD, and BD are simultaneously operated due to an electrical connection therebetween. A same electric current is applied to the red, green, and blue organic electro luminescent devices RD, GD, and BD of the first luminescent group EG1. This also may be implemented, for example, by electrically connecting electrodes of the respective red, green, and blue organic electro luminescent devices to each other in a luminescent group. However, a number of the red organic electro luminescent devices RD, a number of the green organic electro luminescent devices GD, and a number of the blue organic electro luminescent devices BD may be different from each other. In another embodiment, color expression of the red, green, and blue organic electro luminescent devices RD, GD, and BD may be different from each other.

Although the same electric current is applied to the red, green, and blue organic electro luminescent devices RD, GD, and BD, the light amount of the red, green, and blue lights generated by the backlight unit 700 is controlled by the number of the red, green, and blue organic electro luminescent devices RD, GD, and BD or the color expression of the red, green, and blue organic electro luminescent devices RD, GD, and BD. Therefore, the contrast of the image displayed on the screen of the display unit 500 may be increased, so that the display quality of the display apparatus 800 may be improved.

According to the present invention, the backlight unit includes the first light source generating the first light having the first wavelength range and the second light source generating a second light having a second wavelength range different from the first wavelength range to compensate the first light.

Further, the display apparatus may control the light amount of the red, green, and blue lights generated by the backlight unit in response to the red, green, and blue image data applied to the display unit.

Therefore, the contrast and the brightness of the image displayed on the screen of the display unit may be increased and the display quality of the display apparatus may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A backlight unit comprising:
a first light source generating a first light having a first wavelength range;
a second light source generating a second light having a second wavelength range different from the first wavelength range; and
an optical plate having a lower surface facing the second light source, an upper surface substantially parallel with the lower surface, and a side surface to connect the lower surface with the upper surface.

2. The backlight unit of claim 1, wherein the second wavelength range is within the first wavelength range.

3. The backlight unit of claim 1, further comprising a reflecting plate disposed under the optical plate, the reflecting plate reflecting a portion of the first and the second light toward the upper surface of the optical plate.

4. The backlight unit of claim 1, wherein the first light source is disposed adjacent to the side surface of the optical plate.

5. The backlight unit of claim 1, wherein the first light source is disposed under the optical plate.

6. The backlight unit of claim 5, wherein the first light source comprises a plurality of fluorescent lamps disposed substantially parallel with each other, and the second light source is disposed between the fluorescent lamps.

7. The backlight unit of claim 1, wherein the second light source is disposed under the optical plate in a matrix shape.

8. The backlight unit of claim 1, wherein the first light source comprises at least one fluorescent lamp.

9. The backlight unit of claim 1, wherein the second light source comprises at least one organic electro luminescent device.

10. The backlight unit of claim 1, wherein the second light source comprises at least one light emitting diode.

11. The backlight unit of claim 1, wherein the first light emitted from the first light source comprises a white light having a red light, a green light, and a blue light, and the second light emitted from the second light source comprises one of the red light, the green light, and the blue light.

12. The backlight unit of claim 1, wherein the second light source includes:
a first electrode receiving a first voltage;
a second electrode receiving a second voltage; and
a luminescent layer disposed between the first and second electrodes,
wherein an electric field is formed in response to the first and second voltages applied to the first and second electrodes to generate the second light.

13. The backlight unit of claim 12, wherein the luminescent layer includes an organic layer having at least one of red color, green color, and blue color.

14. The backlight unit of claim 12, wherein the first electrode includes metal material having a low work function.

15. The backlight unit of claim 14, wherein the second electrode includes transparent conductive material.

16. A display apparatus comprising:
a backlight unit comprising:
a first light source generating a first light having a first wavelength range;
a second light source generating a second light having a second wavelength range different from the first wavelength range; and
an optical plate having a lower surface facing the second light source, an upper surface substantially parallel with the lower surface, and a side surface to connect the lower surface with the upper surface, and
a display panel displaying images using the first and second lights generated by the backlight unit.

17. The display apparatus of claim 16, wherein the backlight unit further comprises a reflecting plate disposed under the optical plate, the reflecting plate reflecting a portion of the first and the second light toward the upper surface of the optical plate.

18. The display apparatus of claim 16, wherein the first light source comprises at least one fluorescent lamp.

19. The display apparatus of claim 16, wherein the second light source comprises at least one organic electro luminescent device.

20. The display apparatus of claim 16, wherein the second light source comprises at least one light emitting diode.

21. The display apparatus of claim 16, wherein the first light emitted from the first light source comprises a white light having a red light, a green light, and a blue light, and the second light comprises one of the red light, the green light, and the blue light.

22. The display apparatus of claim 21, wherein the display panel comprises:
a red color pixel to transmit the red light;
a green color pixel to transmit the green light; and
a blue color pixel to transmit the blue light.

23. A display apparatus comprising:
a first driving unit generating a first driving signal and a control signal in response to an external signal;
a display unit displaying images in response to the first driving signal, the display unit having a plurality of color areas;
a second driving unit generating a second driving signal in response to the control signal from the first driving unit; and
a backlight unit providing the color areas of the display unit with lights having wavelength ranges different from each other, the backlight unit having a plurality of luminescent groups corresponding to the color areas.

24. The display apparatus of claim 23, wherein each of the luminescent groups comprises a plurality of red organic electro luminescent devices, a plurality of green organic electro luminescent devices, and a plurality of blue organic electro luminescent devices, and electric currents different from each other are applied to the red, green, and blue organic electro luminescent devices, respectively.

25. The display apparatus of claim 24, wherein red, green, and blue organic electro luminescent devices of a luminescent group include first, second, and third electrodes, respectively, receiving the electric currents, the first, second, and third electrodes being electrically insulated from each other.

26. The display apparatus of claim 23, wherein each of the luminescent groups comprises a plurality of red organic electro luminescent devices, a plurality of green organic electro luminescent devices, and a plurality of blue organic electro luminescent devices,
a same electric current is applied to the red, green, and blue organic electro luminescent devices, and
color expressions of the red, green, and blue organic electro luminescent devices are different from each other.

27. The display apparatus of claim 26, wherein the red, green, and blue organic electro luminescent devices of a luminescent group include first, second, and third electrodes, respectively, receiving the same electric current, the first, second, and third electrodes being electrically connected to each other.

28. The display apparatus of claim 23, wherein each of the luminescent groups comprises a plurality of red light emitting diodes, a plurality of green light emitting diodes, and a plurality of blue light emitting diodes, and electric currents different from each other are applied to the red, green, and blue light emitting diodes, respectively.

29. The display apparatus of claim 23, wherein each of the luminescent groups comprises a plurality of red light emitting diodes, a plurality of green light emitting diodes, and a plurality of blue light emitting diodes,
a same electric current is applied to the red, green, and blue light emitting diodes, and
color expressions of the red, green, and blue light emitting diodes are different from one another.
